(19) United States
(12) Patent Application Publication
(10) Pub. No.: US 2008/0229080 A1
(43) Pub. Date: Sep. 18, 2008

(54) ARITHMETIC PROCESSING UNIT

(75) Inventors: Ryuji KAN, Kawasaki (JP); Tomohiro TANAKA, Kawasaki (JP); Toshio YOSHIDA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/037,395

(22) Filed: Feb. 26, 2008

(30) Foreign Application Priority Data
Mar. 16, 2007 (JP) 2007-069613

(51) Int. Cl. G06F 9/302

(52) U.S. Cl. 712/221; 712/E09.017

(57) ABSTRACT

An arithmetic processing unit includes a register file provided with multiple register windows, an arithmetic executor executes an instruction with data retained in the register file as an operand, and a current window pointer which retains address information specifying a register window which becomes a current window, and a controller. The controller controls the address information retained by the current window pointer is updated, when a window switching instruction for indicating switching of the current window has been decoded. The arithmetic executor reads data in a first register window specified by the address information before being updated and data in a second register window specified by the updated address information from the register file, after the decoding of said window switching instruction has been started until commit of the window switching instruction is started.

### BACKGROUND

1. Field

The present disclosure relates to an arithmetic processing unit provided with a register file of a register window scheme, and more particularly, to an arithmetic processing unit which can perform out-of-order execution.

2. Description of the Related Art

A processor implementing a RISC (Reduced Instruction Set Computer) architecture (hereinafter referred to as “RISC processor”) mainly performs register-register arithmetic. A RISC processor intends to accelerate processes by reducing memory accesses. Such architecture is referred to as “load-store architecture”. The RISC processor is provided with a large register file in order to make the register-register arithmetic more efficient. A register file of a register window scheme configured to reduce overhead of passing an argument (save/return of the argument) at the time of invoking a subroutine is known.

FIG. 17 is a diagram showing a configuration of the register file of the register window scheme.

A register file 1000 shown in FIG. 17 comprising 8 lines of register windows W0 to W7. These register windows W0 to W7 are logically coupled with one another in a ring shape. Each register window Wk (k=0 to 7) is provided with 4 kinds of segments (hereinafter referred to as “windows”), that is, W globals, Wk outs, Wk ins and Wk locals. Each of these 4 kinds of windows is configured with 8 registers. W globals is provided with 8 global registers which are commonly used by all subroutines. Wk locals is provided with 8 local registers inherent in each register window. Wk ins is provided with 8 in-registers and Wk outs is provided with 8 out-registers.

Wk outs is used for passing an argument to a subroutine invoked by its own routine. Moreover, Wk ins is used for receiving an argument from a parent routine which has invoked its own routine. Since Wk ins and Wk+1 outs (k+1=0 if k=7) as well as Wk outs and Wk−1 ins (k−1=7 if k=0) are configured to overlap in the register file 1000, the passing of the argument and the securing of the register used for the argument can be accelerated at the time of a subroutine call. Wk locals is used as a working register set by each subroutine, that is, a child routine invoked by its parent routine.

Each subroutine uses any one of the 8 register windows W0 to W7 at the time of executing a process. Here, the register window Wk used by a running subroutine (referred to as “current window”) rotates clockwise (in a direction of a dashed arrow shown by “SAVE”) for two windows each time the subroutine call occurs, and rotates counterclockwise (in a direction of a dashed arrow shown by “RESTORE”) for two windows when the subroutine returns.

Each register window Wk in the register file 1000 is managed with a register window number (referred to as “window number”) assigned thereto. For example, a window number k is assigned to the register window Wk. The number k of the register window Wk used by the running subroutine is retained in Current Window Pointer CWP. A value of CWP is incremented with execution of a SAVE instruction or occurrence of a trap, and decremented with execution of a RESTORE instruction or returning from the trap with a RETT instruction. In FIG. 17, the value of CWP is “0” and CWP specifies the register window W0. An instruction which switches the current window by incrementing or decrementing the value of CWP is herein referred to as “window switching instruction”.

The register file 1000 shown in FIG. 17 is configured with the 8 lines of register windows Wk and one line of window W globals (not shown). W globals is a register set (window) for storing data which is commonly used by all routines. Each register window Wk is provided with 24(=8×3) registers, and the window W globals is provided with 8 registers. Since, among these registers, 64(=8×8) registers of the window Wk ins and the window Wk outs overlap, a total number of registers included in the register file 1000 is 136(=8×24+8−64). It is necessary for the arithmetic device of a processor to be able to read and write data with respect to all registers in the register file 1000 in order for the arithmetic device to execute the subroutine.

However, a size and a speed of a circuit for reading the data from such a large register file 1000 could be a problem. An arithmetic processing unit having a configuration shown in FIG. 18 has been devised to solve the problem.

An arithmetic processing unit 2000 shown in FIG. 18 is configured with a master register file (hereinafter described as MRF) 2001, a working register file (hereinafter described as WRF) 2002, and an arithmetic device 2003. The arithmetic device 2003 is provided with an execution unit for executing the instruction and a memory unit.

Generally, an increase in the number of the register windows in the register file of the register window scheme increases the number of included registers, which makes it difficult to supply an operand to the arithmetic device quickly. Consequently, a processor shown in FIG. 18 is provided with the WRF 2002, in addition to the MRF 2001 provided with all register windows (also including the window W globals). The WRF 2002 retains a copy of data in the current window specified by CWP in the MRF 2001. The supply of the operand to the arithmetic device 2003 is performed from the WRF 2002 in this configuration.

However, if the arithmetic processing unit 2000 has such a configuration, it is not possible to supply an operand required for an instruction following the window switching instruction from the WRF 2002 when the window switching instruction such as the SAVE instruction or the RESTORE instruction is executed, since the WRF 2002 retains only the data in the current window specified by CWR Consequently, the necessary register window data must be transferred from the MRF 2001 to the WRF 2002, causing a problem in which execution of a subsequent instruction stalls until the transfer process is completed.

Moreover, an order in which instructions are executed in a processor provided with an out-of-order execution function is not limited to their order in a program. Processable instructions, rather, are executed first. However, the instruction following the window switching instruction cannot be executed until the necessary register window data is transferred to the WRF 2002, after the window switching instruction has been executed, even if the instruction following the window switching instruction becomes processable.

Such a constraint causes considerable performance deterioration in a processor of a superscalar scheme. A superscalar processor issues a large number of instructions simultaneously, and can perform out-of-order execution of the instructions. Performance deteriorates in such a superscalar processor because an out-of-order execution scheme increases throughput of instruction execution by fetching many instructions, having accumulated those instructions in a buffer, and executing the instructions from the buffer in which the instructions have been accumulated, in order from executable instructions, independently of their execution order in the program.

Consequently, an arithmetic processing unit as shown in FIG. 19 has been devised (for example, see Japanese Patent Laid-Open No. 2003-196086 [U.S. Pat. No. 7,093,110]). An MRF 3001 retains data in the register windows before and after the current window, in addition to the data in the current window, in the arithmetic processing unit 3000 shown in FIG. 19. Moreover, a register group 3113 (for example, 8 8-byte registers) for temporarily retaining the data when the data in the register window is transferred from the MRF 3001 to the WRF 3002 is provided between the MRF 3001 and a WRF 3002.

The arithmetic processing unit 3000 can execute the instruction following the window switching instruction out of order by previously transferring data in register windows specified by CWP+1 and CWP−1 from the MRF 3001 to the WRF 3002 with forecast transfer. It should be noted that, in FIG. 19, a dashed frame CWP denotes the register window specified by CWP, and a dashed frame CWP+1 denotes the register window following the register window specified by CWP. Moreover, a dashed frame CWP−1 denotes the register window just before the register window specified by CWP.

It is assumed that CWP specifies the current register window W3. An arithmetic device 3003 can execute instructions using the register windows W2 to W4 since data in the register windows W2, W3 and W4 is retained in the WRF 3002. Subsequently, the CWP is incremented to specify the register window W4 after the SAVE instruction has been executed, if the SAVE instruction is executed. Then, data in the register window W5 is transferred from the MRF 3001 via the register group 3113 to the WRF 3002, and the data in the register windows W3 to W5 is retained in the WRF 3002. Thereby, the arithmetic device 3003 can execute instructions using the register windows W3 to W5.

However, it is necessary for the WRF 3002 to be provided with 64 registers since the WRF 3002 in the arithmetic processing unit 3000 retains three lines of register windows. Moreover, since a latch register group is provided with 8 registers, 72 registers are required in total. The WRF 2002 is provided with 32 registers since the WRF 2002 in the arithmetic processing unit 2000 of FIG. 18 retains only one line of register window.

Therefore, the arithmetic processing unit 3000 is provided with 40 more registers than those in the arithmetic processing unit 2000, making its circuit size larger. Furthermore, in the arithmetic processing unit 3000, an area, or a circuit size, of a selection circuit (not shown) for transferring the data to the WRF 3002 and the arithmetic device 3003 increases, and also a process of reading the data from the WRF 3002 by the arithmetic device 3003 slows down.

In order to solve this problem, the present applicant has focused on control of an instruction pipeline of the out-of-order execution scheme, and has devised an information processing apparatus having a configuration for transferring/retaining only any one of CWP+1 and CWP−1 with respect to the WRF (see Japanese Patent Laid-Open No. 2007-87108 [US Patent Application Publication 2007-067612]).

FIG. 20 shows a configuration of an information processing apparatus 4000 of Japanese Patent Laid-Open No. 2007-87108 (US Patent Application Publication 2007-067612). As shown in FIG. 20, the information processing apparatus 4000 is provided with a Current window Replace Buffer (CRB) 4030 and a Current Working Register file (CWR) 4020. The CRB 4030 and the CWR 4020 configure the WRF The CWR 4020 is a buffer which retains the data in the current window, and the CRB 4030 is a buffer which stores the data in the register window to be retained next in the CWR 4020. An arithmetic section 4040 is provided with a pipeline which executes the instructions in the out-of-order execution scheme. A control section 4050 controls an MRF 4010 and the CWR 4020 so that the data in the current window to be retained next in the CWR 4020 is transferred from the MRF 4010 to the CRB 4030 when the window switching instruction is decoded by the arithmetic section 4040. Moreover, the control section 4050 causes the data in the register window retained in the CRB 4030 to be transferred to the CWR 4020, and causes the CWR 4020 to retain the data in the register window, when the arithmetic section 4040 completes the execution of the window switching instruction.

The CWR 4020 is provided with register groups 4021 to 4024 which retain data in windows globals (G), locals (L), ins (Io0) and outs (Io1) of the current window. Since each register group is provided with 8 registers, the CWR 4020 is provided with 32(=4×8) registers. The CRB 4030 is provided with register groups 4031 and 4032 which retain only data in windows which do not overlap the data retained in the CWR 4020, among the data in the register window following the current window. The register 4031 retains data in the window locals (L) of the following register window, and the register 4032 retains data in the window ins (Io0) or outs (Io1) of the following register window. Since each of the register groups 4031 and 4032 is provided with 8 registers, the CRB 4030 is provided with 16(=8×2) registers. Therefore, the WRF of the information processing apparatus 4000 is configured with 48 registers.

However, the WRF retains the copy of one register window in the MRF, or storage such as the CRB and the CWR, in both the arithmetic processing unit 3000 and the information processing apparatus 4000. This is costly in hardware and also makes the circuit size larger. Moreover, the information processing apparatus 4000 consumes power for transferring the data from the work buffer ORB 4030, which is provided between the MRF 4010 and the CWR 4020, to the CWR 4020.

It is an object of the present disclosure to realize an arithmetic processing unit which is provided with the register file of the register window scheme and can perform the out-of-order execution of the instruction following the window switching instruction, with a smaller circuit size and lower power consumption than the conventional unit.

### SUMMARY

According to one aspect of this disclosure, an arithmetic processing unit comprises a register file provided with multiple register windows, in which an arithmetic executor executes an instruction with data retained in said register file as an operand; a current window pointer retains address information specifying a register window which becomes a current window, among the multiple register windows included in said register file, and a controller controls such that said address information retained by said current window pointer is updated, when a window switching instruction for indicating switching of said current window has been decoded, and also, said arithmetic executor reads data in a first register window specified by the address information before being updated and data in a second register window specified by said updated address information from said register file, after the decoding of said window switching instruction has been started until commit of said window switching instruction is started.

The above-described embodiments are intended as examples, and all embodiments are not limited to including the features described above.

### BRIEF DESCRIPTION OF THE DRAWINGS

FIG. 1 is a configuration diagram of an arithmetic processing unit according to an embodiment;

FIG. 2 is a diagram showing a detailed configuration of the arithmetic processing unit in the embodiment of FIG. 1;

FIG. 3a is a diagram showing a configuration example of an MRF_RA1;

FIG. 3b is a diagram showing a configuration example of an MRF_RA2;

FIG. 4 is a diagram showing an instruction pipeline of an arithmetic section in the arithmetic processing unit of the embodiment;

FIG. 5 is a diagram showing a configuration example of a port assignment control section table;

FIG. 6 is a diagram illustrating a method of reading a port assignment state from the port assignment control section table;

FIG. 7 is a flowchart showing an update algorithm for cwp and set at the time of executing a SAVE instruction;

FIG. 8 is a flowchart showing the update algorithm for cwp and set at the time of executing a RESTORE instruction;

FIG. 9 is a diagram showing operations of an execution pipeline before and after the SAVE instruction;

FIG. 10 is a diagram showing an example of an execution timing of a following instruction at the time of decoding a window switching instruction;

FIG. 11 is a diagram showing a method of controlling release of a rename register so that a bubble may not occur in the instruction pipeline with respect to instructions in a true data dependency relationship;

FIG. 12 is a diagram showing a control method in the case of requiring multiple cycles for reading data from a register file;

FIG. 13 is a diagram showing an example of utilizing the port assignment control section table;

FIG. 14 is a diagram showing an example of utilizing the port assignment control section table;

FIG. 15 is a diagram showing a configuration example of the embodiment of FIG. 2 applied to an integer arithmetic unit;

FIG. 16 is a diagram showing a configuration example of another register file;

FIG. 17 is a diagram showing a configuration example of a register file of a register window scheme;

FIG. 18 is a diagram showing a configuration of an arithmetic processing unit provided with a register file of a conventional register window scheme;

FIG. 19 is a diagram showing a second configuration of the arithmetic processing unit provided with the register file of the conventional register window scheme; and

FIG. 20 is a diagram showing a third configuration of the arithmetic processing unit provided with the register file of the conventional register window scheme.

### DETAILED DESCRIPTION OF THE PREFERRED EMBODIMENTS

Reference may now be made in detail to embodiments, examples of which are illustrated in the accompanying drawings, wherein like reference numerals refer to like elements throughout.

An embodiment of an information processing apparatus will be described below with reference to the drawings.

An arithmetic processing unit has a register file having register windows. The arithmetic processing unit is provided with an out-of-order execution function according to this embodiment. The out-of-order execution of an instruction following a window switching instruction is also enabled while securing a data reading speed in an arithmetic section, by devising data reading from an MRF, without providing a WRF. According to such a configuration, the arithmetic processing unit of this embodiment realizes lower power consumption by reducing a circuit area of the arithmetic processing unit, as well as reducing power consumption by eliminating data transfer between work buffers (between a CWR and a CRB).

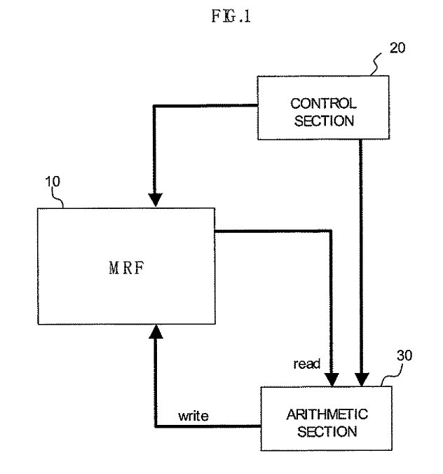

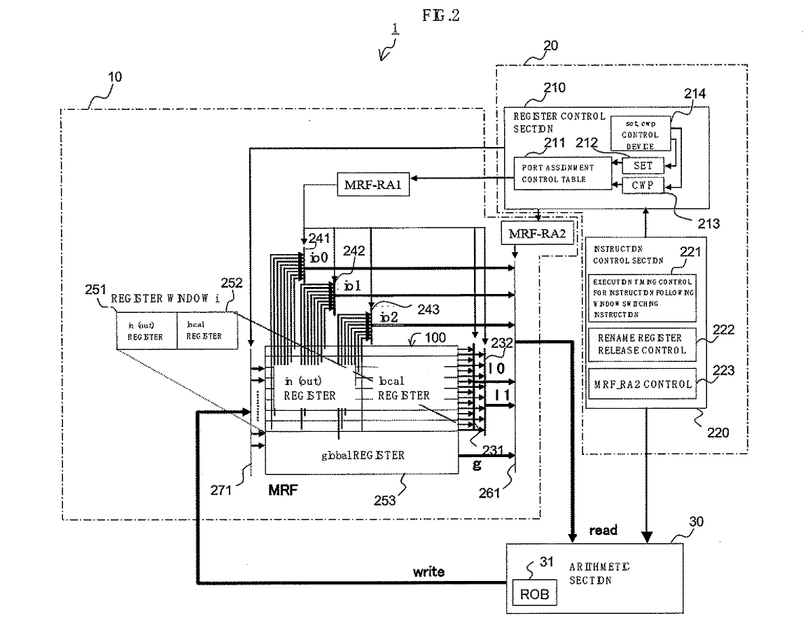

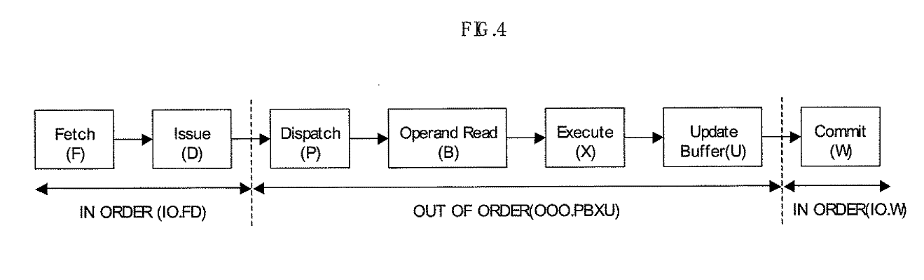

FIG. 1 shows a configuration of the arithmetic processing unit according to an embodiment, and FIG. 2 shows a detailed configuration of the arithmetic processing unit of this embodiment. Moreover, FIG. 4 shows an instruction pipeline which performs the out-of-order execution in the arithmetic processing unit of this embodiment.

The arithmetic processing unit of this embodiment differs from a conventional arithmetic processing unit in that it is not provided with the WRF. In this embodiment, as shown in FIG. 2, a Master Register Read Address 1 (MRF_RA1) and a Master Register Read Address 2 (MRF_RA2) are provided in an MRF 10 shown in FIG. 1. Moreover, control sections (a register control section 210 and an instruction control section 220) which control the MRF_RA1 and the MRF_RA2 are provided in a control section 20. Contents of the MRF_RA1 are updated at the time of issuing or committing an instruction for updating a value stored in a CWP register 213. In this embodiment, the MRF_RA1 is used to read a register window specified by the CWP register 213, from the MRF 10.

As shown in FIG. 2, this embodiment is not provided with storage corresponding to the CRB and the CWR, and most functions included in the storage are realized with a combinational circuit. Contents of the MRF_RA2 are determined at a Dispatch stage in the instruction pipeline, and data to be used by an arithmetic section 30 at an Execute stage following the Dispatch stage is indicated.

By employing a circuit configuration discussed above, unless data retained in the MRF_RA1 or the MRF 10 is not updated, the data is read in one cycle from the MRF_RA2 to the arithmetic section 30, and the out-of-order execution of the instruction in the arithmetic section 30 is enabled. Moreover, after the data retained in the MRF_RA1 or the MRF 10 is updated, if it is assumed that it takes N cycles for the update to have an effect on the data read out to the arithmetic section 30, the out-of-order execution of the instruction in the arithmetic section 30 is enabled in all cases by causing dispatch of a following instruction to be stalled for N-1 cycles after the data retained in the MRF_RA1 or the MRF 10 is updated.

Moreover, data in a register in which an arithmetic result has been once retained at an Update Buffer stage in the instruction pipeline, that is, a reorder buffer (ROB) 31 in FIG. 2, is typically discarded at a Commit stage and written in the MRF 10. Consequently, although the arithmetic section 30 subsequently reads the data from the MRF 10, it becomes unnecessary to stall the dispatch for N-1 cycles after the update of the data retained in the MRF 10, by retaining the read data in the reorder buffer 31 until an N-1th cycle at the Commit stage and reading the arithmetic result from the reorder buffer 31.

As described above, FIG. 1 is a diagram showing a configuration of an embodiment of the arithmetic processing unit.

An arithmetic processing unit 1 shown in FIG. 1 is provided with the MRF 10, the control section 20 and the arithmetic section 30.

The arithmetic processing unit 1 of this embodiment accesses the register window in the MRF 10 specified by CWP to read/write the data with respect to the register window. The arithmetic processing unit 1 of this embodiment accesses the register window with a combinational circuit provided in the control section 20 and the registers provided in the MRF 10 (for example, the MRF_RA1 and the MRF_RA2). The control section 20 outputs a signal for indicating arithmetic execution of the instruction with respect to the arithmetic section 30.

The MRF 10 is a register file of the register window scheme. The register window in the MRF 10 is specified by the CWP register. The arithmetic section 30 reads the data from the register window in the MRF 10 and uses the read data to execute an arithmetic operation instruction, a logical operation instruction or the like. Then, a result of executing the instruction is written in the specified register window in the MRF 10.

FIG. 2 is a diagram showing the detailed configuration of the arithmetic processing unit 1 of FIG. 1, FIG. 4 is a diagram showing the instruction pipeline of the out-of-order execution included in the arithmetic processing unit 1.

First, a configuration of the instruction pipeline shown in FIG. 4 will be described. As shown in FIG. 4, the instruction pipeline of the arithmetic processing unit 1 is configured with a Fetch stage (F), an Issue stage (D), the Dispatch stage (P), an Operand Read stage (B), the Execute stage (X), the Update Buffer stage (U) and the Commit stage (W).

Functions of the respective stages are as follows.

The Fetch stage: read the instruction from a memory.

The Issue stage: decode the instruction and register a result of the decoding in a reservation station.

The Dispatch stage: issue the instruction from the reservation station.

The Operand Read stage: read an operand to an arithmetic device.

The Execute stage: execute the instruction.

The Update Buffer stage: Wait for an execution result.

The Commit stage: Complete the instruction.

The Fetch stage is a stage for reading the instruction from the memory, and the Issue stage is a stage for decoding the instruction and registering the result in the reservation station. The Fetch stage and the Issue stage are executed in order (IO.FD).

The Dispatch stage is a stage for issuing the instruction from the reservation station. Moreover, the Execute stage is a stage for executing the instruction issued from the reservation station. The Update Buffer stage is a stage for waiting for the result of the execution at the Execute stage, in order to realize in-order completion. The Dispatch stage, the Execute stage and the Update Buffer stage are executed out of order (OOO.PBXU).

The Commit stage is a stage for completing the instruction. At the Commit stage, the reservation station is used to realize the in-order completion (IO.W). The reservation station has saved information on whether or not the completion has been performed with respect to the instruction executed by the arithmetic device, or the execution result. At the Commit stage, the instruction is completed in order with reference to the reservation station.

In this way, the instruction pipeline of the arithmetic processing unit 1 has a configuration for executing out-of-order processes for the out-of-order instruction issuing/the in-order completion.

{Configuration of MRF 10}

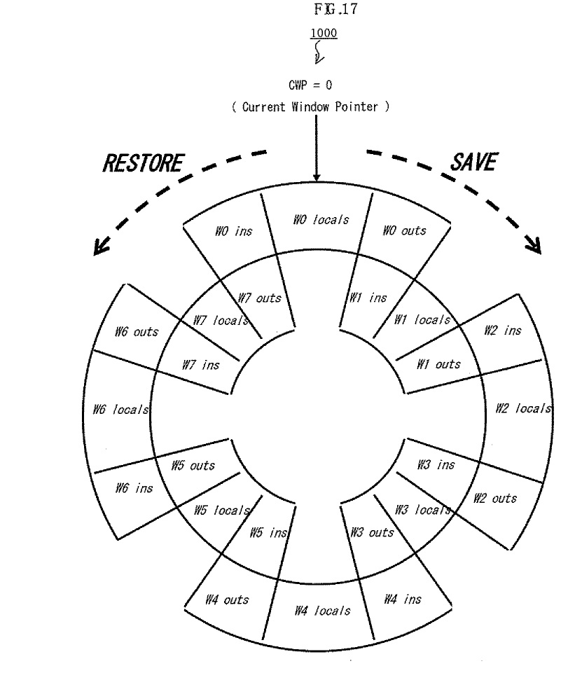

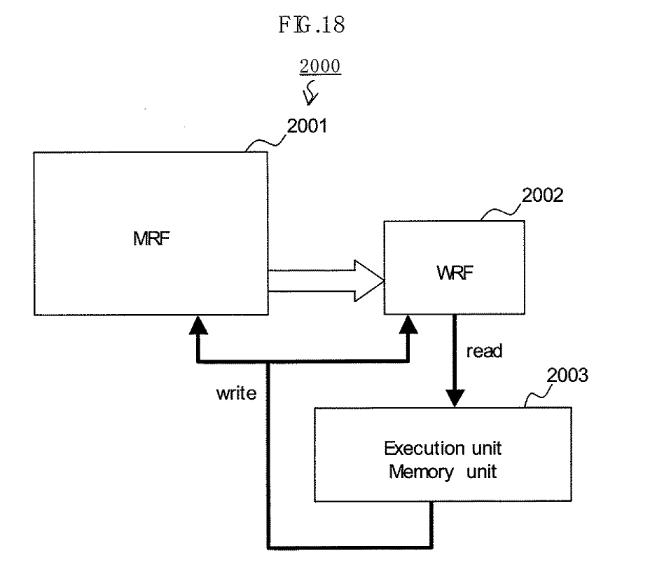

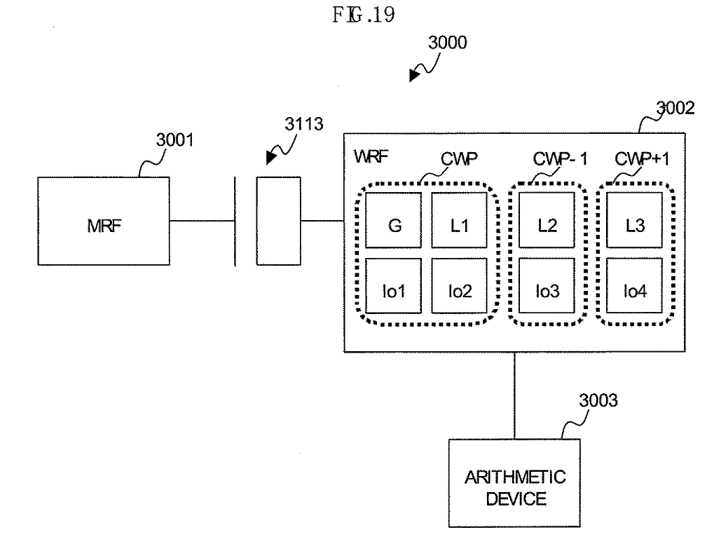

As shown in FIG. 2, the MRF 10 is provided with a register file 100, the MRF_RA1 and the MRF_RA2. The register file 100 is a register file of an overlap window scheme having a similar configuration as the register file 1000 shown in FIG. 17 as described above.

The control section 20 of FIG. 1 is provided with the register control section 210 and the instruction control section 220 shown in FIG. 2.

The register control section 210 is provided with a port assignment control section table 211, a SET register 212, the CWP register 213 and a set, cwp control device 214.

The port assignment control section table 211 is a table in which a value to be set to the MRF_RA1 that is, a port assignment state which will be described later has been stored.

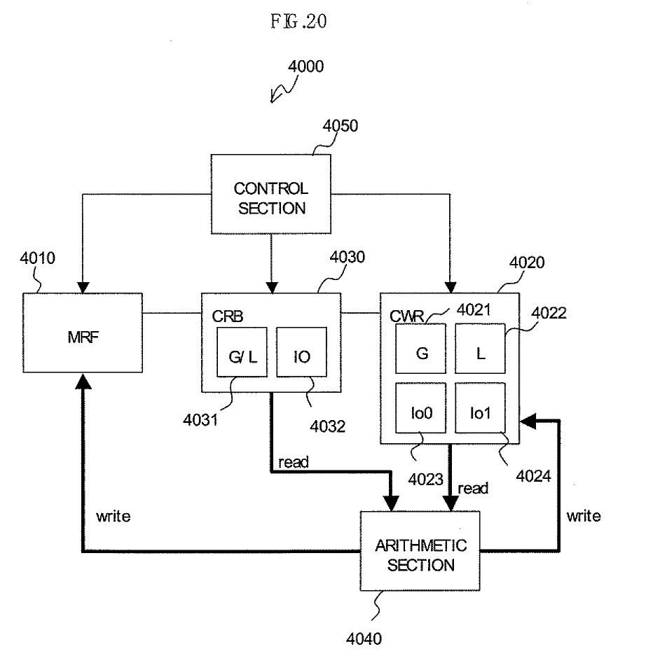

The MRF 10 of this embodiment is provided with 8 register windows which are logically configured in a ring shape, similarly to the MRF 4010 shown in FIG. 20. Moreover, the MRF 10 of this embodiment is provided with the MRF_RA1 and the MRF_RA2. Furthermore, the MRF 10 of this embodiment is provided with five readout ports 10, 11, io0, io1 and io2.

The readout ports 10 and 11 are ports for reading data in a local register of the register window specified in the MRF_RA1. A multiplexer 231 is provided at the readout port 10 and a multiplexer 232 is provided at the readout port 11. To the multiplexers 231 and 232, data in local registers of windows for respective local registers (W0 locals to W7 locals) of 8 register windows (W0 to W7) is inputted.

The readout ports io0, io1 and io2 are ports for reading data in an in-register or an out-register of the register window specified in the MRF_RA1. A multiplexer 241 is provided at the readout port io0 and a multiplexer 242 is provided at the readout port io1. Moreover, a multiplexer 243 is provided at the readout port io2. To the multiplexers 241 to 243, data in in-registers/out-registers of windows for respective in-registers/out-registers (W0 ins to W7 ins, W0 outs to W7 outs) of the 8 register windows (W0 to W7) is inputted.

The MRF_RA1 is a register which stores the value outputted from the control section 20, that is, the port assignment state which will be described later. The value to be set to the MRF_RA1 is updated at the Issue stage or the Commit stage of the instruction for updating the CWP register 213 provided in the register control section 210 (“window switching instruction” or “register window switching instruction”). The arithmetic processing unit 1 uses the value set to the MRF_RA1 to read the data in the register window specified by a current window pointer value of the CWP register 213, from the MRF 10.

The MRF_RA2 is a register which specifies the number of the register read out for each operand by the arithmetic device in the arithmetic section 30, and is controlled by the register control section 210. The MRF_RA2 has a value determined at the Dispatch stage in the instruction pipeline, and indicates the data in the register of the register window read out from the MRF 10, which is used by the arithmetic section 30 at the following Execute stage.

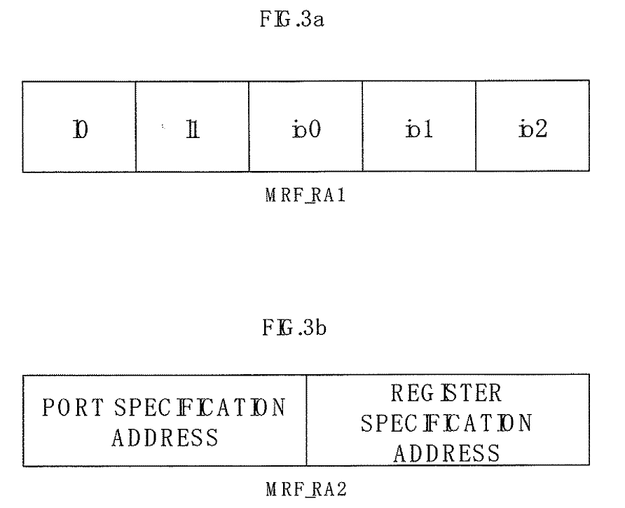

FIG. 3a is a diagram showing a configuration example of the MRF_RA1.

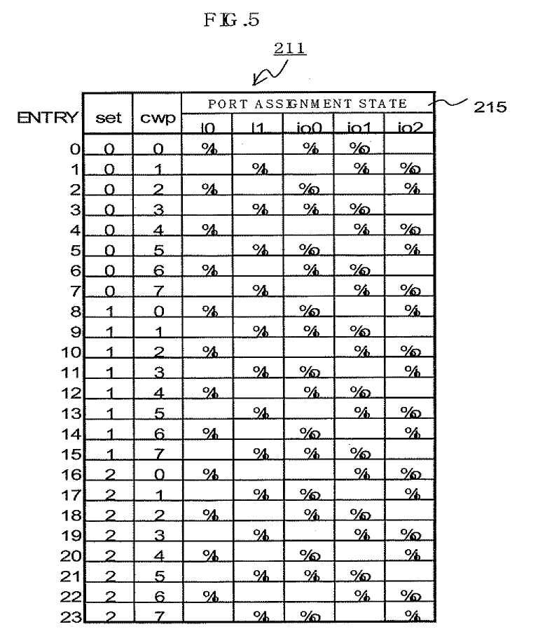

The MRF_RA1 shown in FIG. 3a is provided with areas for storing a port assignment state 215 (five port IDs “I0”, “I1”, “io0”, “io1” and “io2”) shown in FIG. 5. The MRF 10 of this embodiment is provided with eight lines of register windows W0 to W7, and the port IDs I0 and I1 are addresses for specifying one window for the local register among those eight lines of register windows W0 to W7. Moreover, the port IDs io0 to io2 are addresses for specifying one window for the in-register/out-register among the eight lines of register windows W0 to W7. Therefore, a minimum configuration of each of the port IDs I0, I1, io0, io1 and io2 is 3 bits.

FIG. 3b is a diagram showing a configuration example of the MRF_RA2.

The MRF_RA2 shown in FIG. 3b is provided with areas for storing a port specification address for selecting one port among the five readout ports I0, I1, io0, io1 and io2 of the MRF 10 and a register specification address for identifying the register in the window. Since the port specification address specifies one of the five readout ports I0, I1, io0, io1 and io2, the port specification address has a 3-bit configuration at minimum. Moreover, if the register window included in the MRF 10 is configured with eight registers, the register specification address has the 3-bit configuration at minimum. Therefore, in this case, the MRF_RA2 totally has a 6-bit configuration at minimum.

The multiplexer provided at each of the five readout ports I0, I1, io0, io1 and io2 of the MRF 10 has its output controlled with the port ID as a selection signal outputted from the MRF_RA1. FIG. 2 shows a window 251 for the in-register/out-register and a window 252 for the local register of a register window i specified by the value of the CWP register 213. Here, “i” is the value of the CWP register 213. Moreover, a window 253 for a global register is also shown.

Data in the window 251 for the in-register/out-register of the register windows W0 to W7, that is, the data in the eight local registers is outputted to the readout ports io0, io1 and io2 Data in the window 252 for the local register of the specified register window is outputted to the readout ports I0 and I1. The window data output to these readout ports is selectively output by the multiplexers 241 to 243, 231 and 232 provided at the respective ports.

The window data in the register windows selectively outputted from the five multiplexers 231, 232 and 241 to 243 is inputted to a multiplexer 261. Data in the window 253 for the global register is also inputted to the multiplexer 261. According to the port specification address and the register specification address outputted from the MRF_RA2, the multiplexer 261 selects the data in one window among the data in the windows selectively outputted from the five multiplexers 231, 232 and 241 to 243 and the window 253 for the global register, and further selects one among the data in the eight registers included in the data in the selected window. Then, the multiplexer 261 outputs the data in the selected register to the arithmetic section 30.

The MRF 10 is further provided with a multiplexer 271. This multiplexer 271 outputs write data such as an arithmetic result with respect to the MRF 10, which is inputted from the arithmetic section 30, to the selected register. The multiplexer 271 is controlled by the register control section 210, and outputs the write data to the register specified by the arithmetic section 30.

If the register file 100 included in the MRF 10 is configured with the eight register windows like this embodiment, when the value of the CWP register 213 (hereinafter referred to as “cwp”) has been changed with the window switching instruction such as a SAVE instruction or a RESTORE instruction, a minimum number of states which cover all combinations for assigning the window for the out-register (outs) of a current window before being switched and the window for the in-register (Ins) of the current window after being switched, which are physically the same register, to the same readout port of the MRF 10 is 24. Since cwp takes eight values of “0” to “7”, when cwp goes around the values of “0” to “7” for three times, the state returns to an original state. Consequently, cwp going around “0” to “7” for three times is regarded as one set. Therefore, “0” to “2” are assigned as values in the SET register 212 (hereinafter referred to as “set”) and these values are cyclically changed each time the window switching instruction is executed.

As shown in FIG. 5, 24 kinds of states are determined by combinations of the values of cwp which can take eight values and set which can take three values. In this embodiment, as shown in FIG. 5, “port assignment state 215” is assigned to each of the 24 kinds of states, and these 24 kinds of port assignment states 215 are associated with the combinations of the values of set and cwp and stored in the port assignment control section table 211. The port assignment state 215 is configured with the port IDs of the five readout ports “I0”, “I1”, “io0”, “io1” and “io2” of the MRF 10. These port IDs are output selection signals of the corresponding readout ports of the MRF_RA1.

FIG. 5 is a diagram showing a configuration example of the port assignment control section table 211.

As shown in FIG. 5, the port assignment control section table 211 is provided with 24 entries, and information on the 24 kinds of states is stored in those entries corresponding to a state cycle order. A record in each entry of the port assignment control section table 211 is configured with “set”, “cwp” and “port assignment state 215”. Set denotes a set number of the set, and cwp denotes the value of the CWP register 213, that is, a register window number specified at the current window. A pair of set and cwp (set, cwp) is an index of the port assignment control section table 211.

The port assignment state 215 is configured with the five port IDs corresponding to the five readout ports I0, I1, io0, io1 and io2 of the MRF 10 shown in FIG. 2. The port ID I0 corresponds to the readout port I0, the port ID I1 corresponds to the readout port I1, the port ID io0 corresponds to the readout port io0, the port ID io1 corresponds to the readout port io1, and the port ID io2 corresponds to the readout port io2.

% I is set to the port IDs I0 and I1, and % i or % o is set to the port IDs io0 to io2. % I, % i and % o are addresses for specifying the window for the local register, the window for the in-register and the window for the out-register of the register window of the MRF 10 specified by cwp, respectively. % I is the address for specifying the window for the local register of any one of the eight lines of register windows W0 to W7 included in the MRF 10. % i is the address for specifying the window for the in-register of any one of the eight lines of register windows W0 to W7. Moreover, % o is the address for specifying the window for the out-register of any one of the eight lines of register windows W0 to W7.

In each state, two fields are blank among five fields in the port assignment state 215. These blanks represent “no address specification”. % I is inputted as a selection signal to the multiplexers 231 and 232 provided at the respective readout ports I0 and I1 of the local register in the MRF 10. % i and % o are inputted as selection signals to the multiplexers 241 to 243 provided at the respective readout ports io0, io1 and io2 of the in-registerlout-register in the MRF 10.

Therefore, for example, when the port assignment state 215 of (set,cwp)=(0,2) is set to the MRF_RA1, the window for the local register Wk locals, the window for the in-register Wk ins, and the window for the out-register Wk outs, which are specified by % I, % i and % o, are outputted from the readout ports I0, io2 and io0 of the MRF 10, respectively. In this condition, if the window switching instruction is decoded and cwp is incremented by “1” to transit to (set,cwp)=(0,3), the window for the local register Wk locals, the window for the in-register Wk ins, and the window for the out-register Wk outs, which are specified by % I, % i and % o, are outputted from the readout ports I1, io0 and io1 of the MRF 10, respectively. In this case, the window for the local register Wk locals and the window for the in-register Wk ins, which have been specified by the port assignment state 215 of (set,cwp)=(0,2), are outputted from the readout ports I0 and io2 of the MRF 10, respectively. This enables the out-of-order execution of an instruction preceding the window switching instruction, which uses the register window W2 specified by cwp=2, and an instruction following the window switching instruction, which uses the register window W3 specified by cwp=3. Subsequently, when the commit of the window switching instruction is started, only the port assignment state 215 of (set,cwp)=(0,3) becomes valid, and the readout ports I0 and io2 of the MRF 10 are closed. This prohibits the execution of the instruction preceding the window switching instruction. This is because the instruction pipeline of this embodiment has the in-order completion.

In this embodiment, two readout ports of the local register are provided in the MRF 10, and each time the switching of the register window occurs, the local register of the current window is read out alternately from these two readout ports I0 and I1. Moreover, in the MRF 10, three readout ports of the in-register/out-register are provided. In this case, since the out-register of the current window before being switched and the in-register of the current window after being switched are physically the same register, these registers perform reading from the same readout port, and each time the window switching instruction is executed, the readout port of the in-register is switched cyclically as io0→io1→io2→io0→io1. In this embodiment, control of reading the window data from the five readout ports of the MRF 10 is enabled by storing the port assignment state 215 in the 24 entries of the port assignment control section table 211 in a form as shown in FIG. 5.

The set, cwp control device 214 controls setting of the values of the SET register 212 and the CWP register 213. Window switching information is inputted to the register control section 210 from the instruction control section 220. This information is, for example, information showing whether the instruction to be decoded is the SAVE instruction or the RESTORE instruction. If the instruction to be decoded is the SAVE instruction, the set, cwp control device 214 increments cwp by “1”. By incrementing cwp, if cwp becomes “8”, cwp is reset to “0” and set is incremented by “1”. By incrementing set, if set becomes “3”, set is reset to “0”.

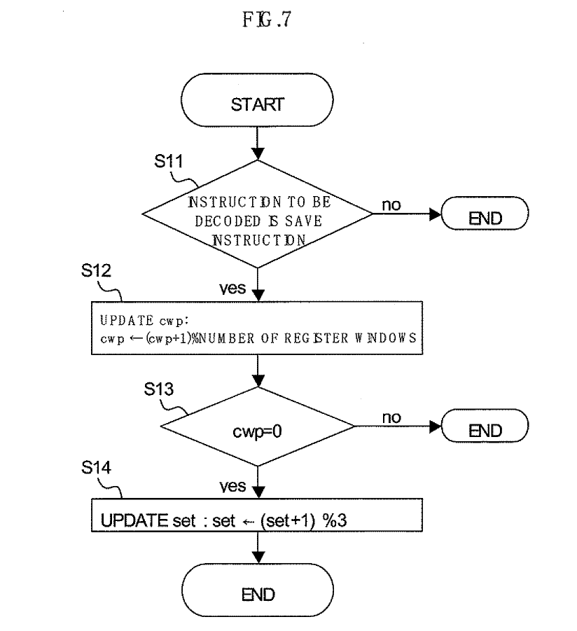

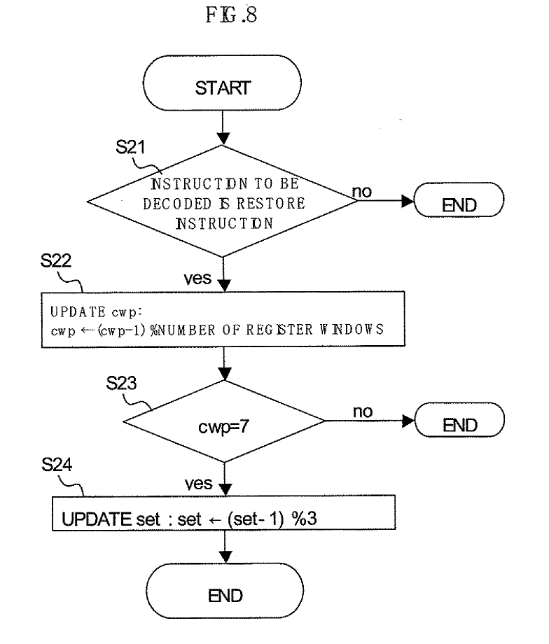

FIGS. 7 and 8 show process flows of the set, cwp control device 214 in the case where the instruction to be decoded is the SAVE instruction and the case where the instruction to be decoded is the RESTORE instruction, respectively.

First, a flowchart of FIG. 7 will be described. It should be noted that an operator % shown in FIGS. 7 and 8 that a remainder in the case of dividing a by b is obtained if the operator % is used in a formula a % b.

The set, cwp control device 214 checks the window switching information inputted from the instruction control section 220 and determines whether or not the instruction to be decoded is the SAVE instruction (S11). If the instruction to be decoded is not the SAVE instruction, the process is completed. On the other hand, if it is determined that the instruction to be decoded is the SAVE instruction at operation S11, cwp is incremented by “1” and subsequently a result of the increment is divided by the number of the register windows (eight in the case of this embodiment) to obtain the remainder. Then, the remainder is set to cwp and cwp is updated (S12).

Next, it is determined whether or not cwp is “0” (S13), and if cwp is not “0”, the process is completed. If it is determined that cwp is “0” at operation S13, set is incremented by “1” and next a result of incrementing set is divided by “3”. Then, the remainder is set to set, set is updated (S14), and the process is completed.

Next, a flowchart of FIG. 8 will be described.

The set, cwp control device 214 checks the window switching information inputted from the instruction control section 220 and determines whether or not the instruction to be decoded is the RESTORE instruction (S21). If the instruction to be decoded is not the RESTORE instruction, the process is completed. On the other hand, at operation S22, its decrement result is divided by the number of the register windows to obtain the remainder, Then, the remainder is set to cwp and cwp is updated (S22).

Next, it is determined whether or not cwp is “7” (S23), and if cwp is not “7”, the process is completed. If it is determined that cwp is “7” at S23, set is decremented by “1” and next a result of decrementing set is divided by “3” Then, the remainder is set to set, set is updated (S24), and the process is completed.

Initial values of set and cwp are “0”. According to the processes of FIGS. 7 and 8, the value of cwp is incremented by “1” each time the SAVE instruction is decoded, and decremented by “1” each time the RESTORE instruction is decoded. When the value of cwp becomes “8” by decoding the SAVE instruction, the value of cwp is reset to “0”, and when the value of cwp becomes “−1” by decoding the RESTORE instruction, the value of cwp is set to “7”. Therefore, the value of cwp circulates in a range of “0” to “7”. Moreover, when the value of cwp becomes “8” by decoding the SAVE instruction, the value of set is incremented by “1”. Moreover when the value of set becomes “3” by decoding the SAVE instruction, the value of set is reset to “0”. Moreover, when the value of cwp becomes “−1” by decoding the RESTORE instruction, the value of set is decremented by “1”. In this way, the value of set circulates in a range of “0” to “2” depending on the decoding of the SAVE instruction and the RESTORE instruction. Here, again, the port assignment control section table 211 will be continuously described.

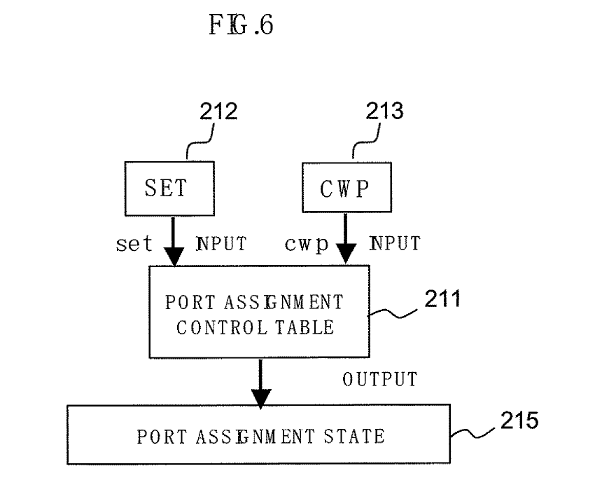

When the value of the SET register 212 (set) and the value of the CWP register 213 (cwp) of FIG. 2 are inputted, the port assignment control section table 211 outputs the port assignment state 215 (I0, I1, io0, io1 and io2) stored in the entry corresponding to the combination of set and cwp (set, cwp) to the MRF_RA1 of FIG. 2 (see FIG. 6).

Next, a configuration of the instruction control section 220 will be described.

The instruction control section 220 is provided with an execution timing control function 221 for the instruction following the window switching instruction, a rename register release control function 222 and an MRF_RA2 control function 223.

The execution timing control function 221 is a control function of causing the decoding of the instruction following the window switching instruction to be stalled until the MRF_RA1 is updated and the reading of the register file from the MRF 10 is enabled. The instruction control section 220 uses this control function to control the arithmetic section 30 to perform the stalling. This control will be described in detail later.

The rename register release control function 222 is a control function of releasing a source of a rename register 31 with the completion of the instruction and causing the released source to be available to an instruction to be newly decoded. The instruction control section 220 uses this control function to control the arithmetic section 30 to execute the release of the source of the rename register.

The MRF_RA2 control function 223 is a function of interpreting an operand register number included in the instruction. Via the register control section 210, the instruction control section 220 controls the MRF_RA2 to cause the data in the register specified by the operand register number to be selectively outputted from the multiplexer 261.

The arithmetic section 30 is provided with an instruction pipeline mechanism of FIG. 4. Moreover, the arithmetic section 30 is also provided with the reorder buffer 31 which is a hardware mechanism for supporting register renaming, the out-of-order execution and the like. The reorder buffer 31 retains a latest value or an update tag of the register in order and is used for executing the out-of-order instruction issuing, the in-order completion, the register renaming and the like. The reorder buffer 31 is provided with the rename register for performing the register renaming. Moreover, the reorder buffer 31 is provided with a function of retaining the arithmetic result at the Update Buffer stage once.

If transfer of the register data from the MRF 10 to the arithmetic section 30 requires multiple cycles, a timing at which the register data in the register window which has been newly switched cannot be read occurs.

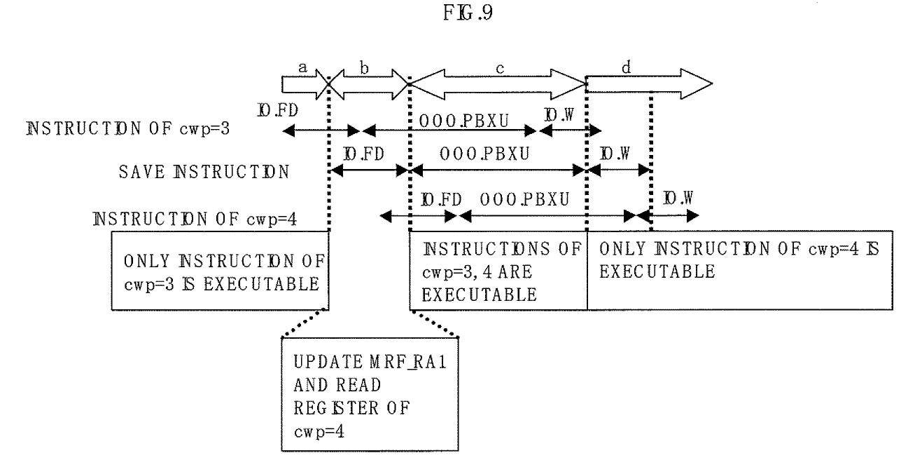

FIG. 9 is a diagram showing an operation of an execution pipeline before and after the SAVE instruction.

In FIG. 9, IO.FD denotes the Fetch stage (F stage) and the Issue state (D stage) which are executed in order, Moreover, OOO.PBXU denotes the Dispatch stage (P stage), the Operand Read stage (B stage), the Execute stage (X stage) and the Update Buffer stage (U stage) which are executed out of order. Moreover, IO.W denotes the Commit stage (W stage) which is completed in order.

FIG. 9 shows the pipeline operation in which the SAVE instruction is executed after an instruction in which the value of the CWP register 213 (cwp) is “3”, and next, an instruction in which the value of the CWP register 213 is “4” is executed.

When the arithmetic section 30 executes three instruction columns in the instruction pipeline, the arithmetic section 30 executes the instructions in order of the instruction of cwp=3, the SAVE instruction and the instruction of cwp=4, until IO.FD. At this time, when the arithmetic section 30 decodes the SAVE instruction at the D stage (if the arithmetic section 30 executes the Issue stage in a period of b of FIG. 9), the value of the CWP register 213 is incremented by the set, cwp control device 214, and the value of the CWP register 213 becomes “4”. Thereby, a new port assignment state 215 corresponding to cwp=4 is transmitted from the port assignment control section table 211 to the MRF_RA1. When the new port assignment state 215 is set to the MRF_RA1, the register window data of cwp=4 specified by the CWP register 213 is read from the five readout ports of the MRF 10. At this time, until it becomes possible for the arithmetic section 30 to read the register window data of cwp=4 (until the period of b of FIG. 9 ends), the arithmetic section 30 causes the decoding of the instruction of cwp=4 following the SAVE instruction to be stalled for certain cycles and controls the execution of the instruction of cwp=4 so that it is not started.

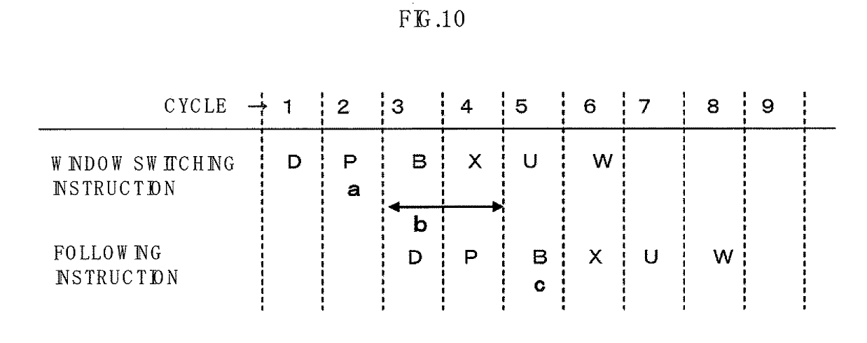

FIG. 10 is a diagram showing an example of an execution timing of the instruction following the window switching instruction when the window switching instruction has been decoded.

In cycle 1 the window switching instruction is decoded (D) at the arithmetic section 30, and in cycle 2, a signal for indicating modification of the MRF_RA1 is transmitted from the instruction control section 220 to the register control section 210 (a of FIG. 10). Then, in cycles 3 and 4, the MRF_RA1 is updated by the register control section 210 (b of FIG. 10). In this case, during a period shown by b of FIG. 10, the data in the register window required for executing the instruction following the window switching instruction cannot be read from the MRF_RA1, due to the update of the MRF_RA1. In cycle 5 (c of FIG. 10) or later, it becomes possible for the arithmetic section 30 to read the data in the register window from the MRF 10. Therefore, in this case, in cycle 2 following cycle 1 in which the decoding of the window switching instruction has been executed, the decoding of the following instruction is stalled. Therefore, in this case, the execution of the following instruction is stalled only for one cycle.

In this embodiment, if the transfer of the data in the register from the MRF 10 to the arithmetic section 30 requires multiple cycles, a timing at which the arithmetic section 30 cannot read the data occurs, which is triggered by writing the data to the MRF 10. In the case where the arithmetic section 30 cannot read the data, a pipeline bubble occurs in the instruction pipeline if there is no other instruction to be assigned with an execution right. In this embodiment, this pipeline bubble is suppressed by controlling the release of the rename register 31.

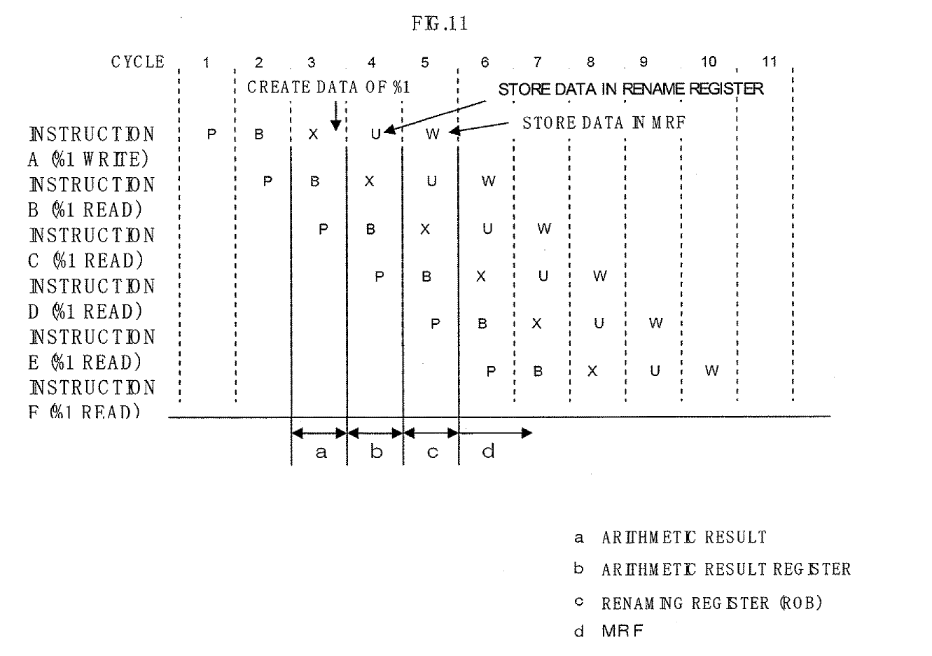

FIG. 11 is a diagram showing a method of controlling the release of the rename register 31, so that the pipeline bubble may not occur in the instruction pipeline with respect to instructions in a true data dependency relationship. In FIG. 11, % 1 denotes the register.

It is assumed that the arithmetic section 30 executes an instruction column of instructions A to F shown in FIG. 11. The instructions A to F are in the true data dependency relationship. In other words, the instruction A is an instruction for writing data in the register % 1 and updates the register % 1. Each of the instructions B to F which are the instructions following the instruction A is an instruction for reading the data in the register % 1 and uses the data in the register % 1.

FIG. 11 is an implementation example in which the data can be read from the register file 100 in the MRF 10 in one cycle. The instructions are subjected to pipeline processing in an order shown in FIG. 4 in which the register address is transferred at the P stage, the data in the register is read at the B stage, the arithmetic is performed (the instruction is executed) at the X stage, the arithmetic result (the result of executing the instruction) is written to the rename register 31 at the U stage, and the data (the arithmetic result) is written to the MRF 10 at the W stage.

In the execution of the instruction column, a result of executing the instruction A is stored in the rename register 31 in cycle 4 and stored in the MRF 10 in cycle 5. Consequently, the result of executing the instruction A can be read from the MRF 10 in cycle 6 or later. Therefore, the instruction B following the instruction A uses the result of executing the preceding instruction A (a) by bypassing it in cycle 3, and the following instruction C uses the result of executing the preceding instruction A by reading it from an arithmetic result register (b) in cycle 4. Moreover, the following instruction D uses the result of executing the preceding instruction A by reading it from the rename register (c) in cycle 51 and the following instructions E and F use the result of executing the preceding instruction A by reading it from the MRF 10 (d) in cycles 6 and 71 respectively.

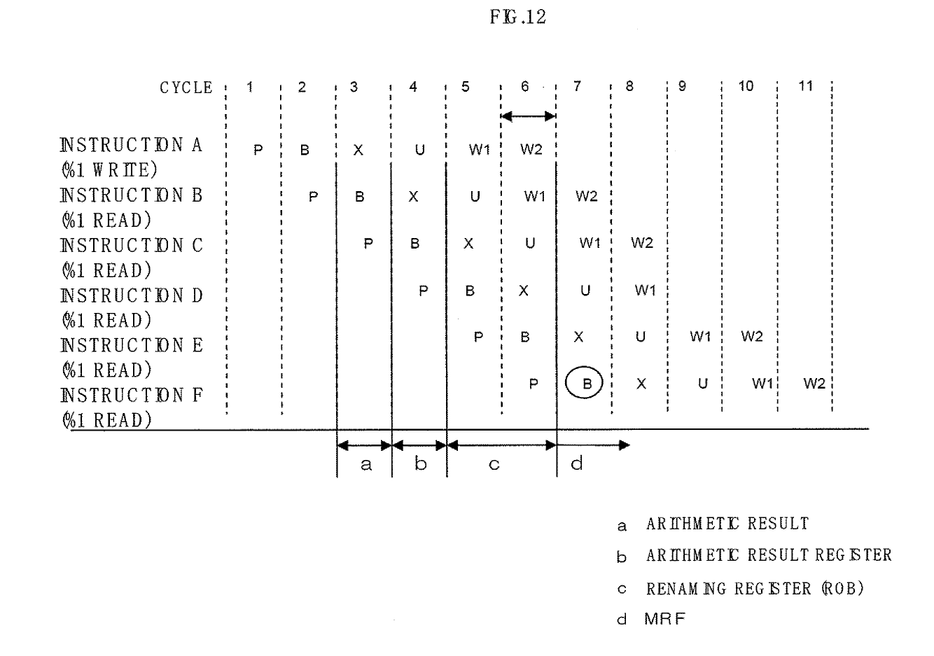

Next, FIG. 12 shows a control method in the case of requiring multiple cycles for reading the data from the register file (MRF 10).

In this embodiment, after the data has been written in the MRF 10, if the data cannot be read from the MRF 10 for a certain period of time, the data is controlled to be read from the rename register 31 instead of the MRF 10 during the period. FIG. 12 shows an example in the case of requiring two cycles for reading the data from the MRF 10.

As shown in FIG. 12, in the case of this embodiment, the W stage has two cycles (W1 and W2) instead of one cycle in the instruction pipeline, and during this period, the result of executing the instruction A is retained in the rename register 31. As a result, the result of updating by the instruction A can be read from the MRF 10 in cycle 7 or later. In this case, the reading of the result of executing the instruction A in the instructions B, C and D following the instruction A is controlled similarly to the case of FIG. 11 (a, b). However, with respect to the following instruction E, the data is controlled to be read from the rename register (c) instead of the MRF 10 in cycle 6. Moreover, with respect to the instruction F, the result of executing the preceding instruction A is controlled to be read from the MRF 10 (d) in cycle 7.

In this way, in this embodiment, although a start timing in which the data can be read from the MRF 10 delays, problems associated with it are prevented by delaying the release of the rename register 31.

This embodiment has been applied to the control of reading the data from the MRF 10 before and after switching the window, by using the port assignment control section table 211, with respect to the MRF 10 provided with the eight lines of register windows.

A method of reading the register from the readout ports of the MRF 10 in this embodiment will be described with reference to FIGS. 5, 13 and 14.

Although the MRF 10 is provided with the local register, the in-register, the out-register and the global register, since the global register is common to all register windows and the window switching has no effect on it, the global register will be omitted in the following description.

The MRF 10 of this embodiment is provided with two local register ports (I0 and I1) for reading the data in the local register, and three in-register/out-register ports (io0, io1 and io2) for reading the data in the in-register/out-register.

One local register port and two in-register/out-register ports are used with respect to one CWP. Consequently, one remaining local register port and one remaining in-register/out-register port are not used. When the value of CWP is switched, in order to read the local register and the out-register (in-register) of the register window specified by a new value of CWP, the unused readout ports of the MRF 10 are assigned to the respective registers.

As shown in FIG. 5, since the 24 states make one time cycle, the MRF_RA1 is controlled in this time cycle. In the following description, CWP denotes the CWP register 213 of FIG. 2 and cwp denotes the value of the CWP register 213.

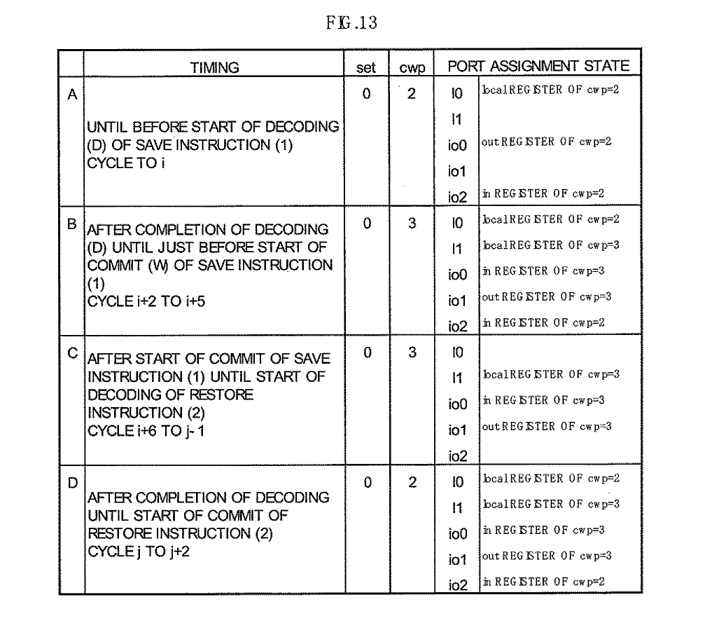

Now, as shown in table A of FIG. 13, a condition of (set,cwp)=(0,2) is assumed. In this case, the register control section 210 performs the control so that the local register is read from the I0 port of the MRF 10, the in-register is read from the io2 port, and the out-register is read from the io0 port. Moreover, the register control section 210 performs the control so that the register reading from the I1 port and the io1 port is not performed.

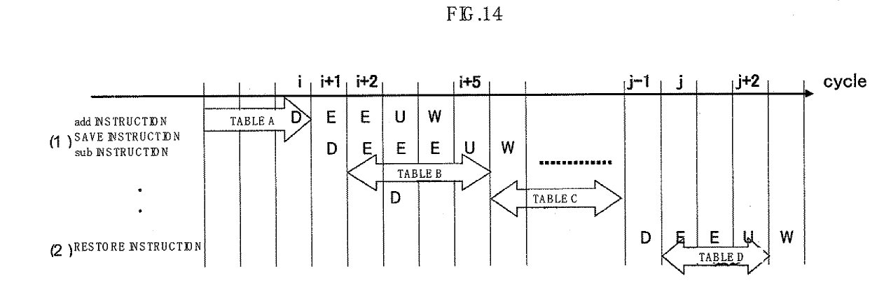

In this condition, if the SAVE instruction is executed ((1) of FIG. 14), cwp is incremented by “1” to transit to (set,cwp)=(0,3) (see table B of FIG. 13). The contents of the MRF_RA1 are modified at a timing of decoding (0) this SAVE instruction, and after completion of the decoding (D) until start of the commit (W) of the SAVE instruction, the local register is read from the I0 port of the MRF 10, the data in the in-register is read from the readout port io2, and the data in the out-register is read from the readout port io1, at cwp=2. Moreover, the data in the local register is read from the readout port I1, the data in the in-register is read from the readout port io0, and the data in the out-register is read from the readout port io1, at cwp=3 (see table B of FIG. 13 with respect to the above description).

Furthermore, when the SAVE instruction is committed (W), the register reading from the readout port I0 and the readout port io2 of the MRF 10 is not performed. This is because the instruction of cwp=2 preceding the SAVE instruction in a program does not subsequently refer to the register since the commit is performed in order. The present disclosure is not limited thereto, and the reading can also be continuously performed depending on the situation.

Subsequently, when the RESTORE instruction is executed, cwp is decremented by “1” to transit to a condition of (set,cwp)=(0,2). The contents of the MRF_RA1 are modified at a timing of decoding (D) this RESTORE instruction, and until this RESTORE instruction is completed (table D of FIG. 13), the data in the local register is read from the readout port I1 of the MRF 10, the data in the in-register is read from the readout port io0 of the MRF 10, and the data in the out-register is read from the readout port io1 of the MRF 10, at cwp=3. Moreover, the data in the local register is read from the readout port 10 of the MRF 10, the data in the in-register is read from the readout port io2 of the MRF 10, and the data in the out-register is read from the readout port io0 of the MRF 10, at cwp=2.

As described above, the MRF_RA1 is controlled by the register control section 210, and the out-of-order execution of multiple instructions existing before and after the window switching instruction in the program is enabled. It should be noted that although OOO.PBXU is shown by one line in FIG. 9, “instruction of cwp=3” and “instruction of cwp=4” represent the multiple instructions, and there are also the same number of execution start timings as the number of the instructions. In an interval c of FIG. 9, OOO.PBXU of cwp=3 and OOO.PBXU of cwp=4 overlap, which shows that the out-of-order execution may occur in which the instruction of cwp=4 is executed at an earlier timing than the instruction of cwp=3.

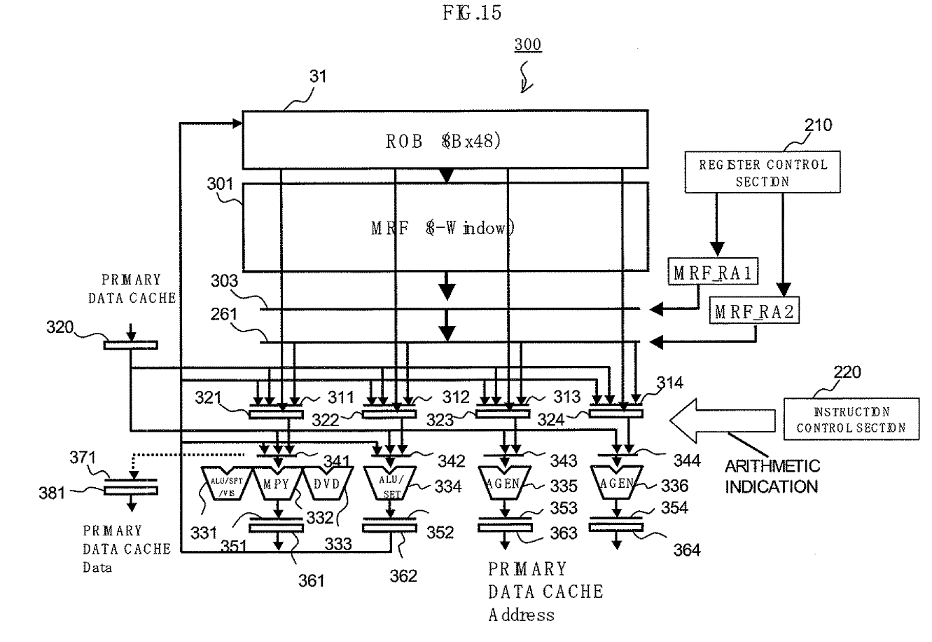

FIG. 15 is a diagram showing a configuration example of the arithmetic processing unit applied with the embodiment of FIG. 2. In FIG. 15, the same components as those of FIG. 2 are given the same reference numerals and the same names.

An arithmetic processing unit 300 shown in FIG. 15 employs a reorder buffer scheme for the register renaming. This register renaming is performed by using the reorder buffer 31. Both a fixed-point arithmetic pipeline and an address arithmetic pipeline of the arithmetic processing unit 300 are configured to be processed at three stages of priority obtaining (P-stage), register reading (B-stage) and arithmetic (X-stage).

There are two lines of fixed-point arithmetic pipelines. One pipeline is provided with an ALU (Arithmetic Logic Unit), a SHIFT arithmetic device (SFT), a multiplier (MPY), a divider (DVD) and a VIS (Virtual Instruction set) arithmetic device, and the other pipeline is provided with the ALU and the SHIFT arithmetic device. Moreover, there are two lines of address arithmetic pipelines separately from the fixed-point pipelines.

The MRF 10 is provided with the eight lines of register windows. The program performs tasks on the register belonging to the current window, and the window switching is mainly performed by the window switching instruction at the time of invoking and returning of a subroutine. The data in the current window has been previously selected from the MRF 10, and when the arithmetic is executed, source data (source operand) can be supplied to the arithmetic device in one cycle. Furthermore, with the decoding of the window switching instruction as a trigger, data in a register window of a switching destination is also controlled to be previously selected from the MRF 10, and the instructions are not delayed even in the case of invoking the subroutine.

The configuration of the arithmetic processing unit 300 will be described in more detail.

An MRF 301 is a block showing the eight lines of register windows shown particularly in FIG. 2. Moreover, a multiplexer 303 shows the five multiplexers 231, 232, 241 to 243 of FIG. 2 integrally, and is controlled by the MRF_RA1. The reorder buffer 31 is provided with the rename register, and retains the result of the arithmetic executed out of order until it is committed in order. An entry of the ROB 31 is secured at the time of decoding and released at the time of committing. In the entry of the ROB 31, for example, a set of the address of the register written by the instruction and the value of the register is stored.

The arithmetic processing unit 300 shown in FIG. 15 is provided with four multiplexers 311 to 314 at a stage subsequent to the multiplexer 261 controlled by the MRF_RA2. To these multiplexers 311 to 314, an output of the multiplexer 261, an output of a register 320 retaining data in a primary data cache, and outputs of registers 361 and 362 retaining the arithmetic result of the arithmetic device are inputted. According to a control signal inputted from the instruction control section 220, the multiplexers 311 to 314 select one of multiple input data and output it to registers 321 to 324 provided at stages subsequent to the multiplexers 311 to 314 respectively. In other words, an output of the multiplexer 311 is retained in the register 321, an output of the multiplexer 312 is retained in the register 322, an output of the multiplexer 313 is retained in the register 323, and an output of the multiplexer 314 is retained in the register 324.

Data retained in the register 321 is outputted to a multiplexer 341, and data retained in the register 322 is outputted to a multiplexer 342. Moreover, data retained in the register 323 is outputted to a multiplexer 343, and data retained in the register 324 is outputted to a multiplexer 344. To the multiplexers 341 to 344, the data in the primary data cache is also inputted from the register 320. To the multiplexers 341 and 342, the arithmetic results retained in the registers 361 and 362 are also inputted.

The multiplexer 341 selects one of three input data and outputs it as operand data to an ALU/SFTNIS arithmetic device 331, a multiplier (MPY) 332 or a divider (DVD) 333. The multiplexer 342 selects one of three input data and outputs the selected data as the operand data to an ALU/SFT arithmetic device 334. The multiplexer 343 selects any one of two input data and outputs it to an address generator (AGEN) 335. The multiplexer 344 selects any one of two input data and outputs it to an address generator (AGEN) 336.

The ALU/SFTNIS arithmetic device 331, the multiplier 332 and the divider 333 output the arithmetic results to a multiplexer 351. The ALU/SFT arithmetic device 334 outputs the arithmetic result to a multiplexer 352. The address generator 335 outputs the arithmetic result (address) to a multiplexer 353. The address generator 336 outputs the arithmetic result (address) to a multiplexer 354.

The multiplexer 351 inputs the arithmetic results of the ALU/SFTNIS arithmetic device 331, the multiplier 332 and the divider 333, selects one of those arithmetic results, and outputs the selected arithmetic result to the register 361. The multiplexer 352 inputs the arithmetic result of the ALUISFT arithmetic device 334 and outputs the arithmetic result to the register 362. The multiplexer 353 inputs the arithmetic result of the address generator 335 and outputs the arithmetic result to a register 363. The multiplexer 354 inputs the arithmetic result of the address generator 336 and outputs the arithmetic result to a register 364.

The register 361 outputs the arithmetic result inputted from the multiplexer 351 to the ROB 31, the multiplexers 311 to 314, and the multiplexers 341 and 342. The register 362 outputs the arithmetic result inputted from the multiplexer 352 to the ROB 31, the multiplexers 311 to 314, and the multiplexers 341 and 342.

The register 363 outputs the arithmetic result inputted from the multiplexer 353 as the address to the primary data cache. The register 364 outputs the arithmetic result inputted from the multiplexer 354 as the address to the primary data cache.

The selectively outputted data of the multiplexers 341 and 342 are outputted to a multiplexer 371. The multiplexer 371 outputs the selectively outputted data to a register 381. The register 381 retains the selectively outputted data and outputs it as the data to the primary data cache.

Incidentally, the registers 321, 322, 323 and 324 provided between the multiplexers 311, 312, 313 and 314 and the arithmetic devices 331 to 333, the arithmetic device 334, the arithmetic device 335 and the arithmetic device 336 are provided in order to separate the B stage from the X stage in the instruction pipeline shown in FIG. 4.

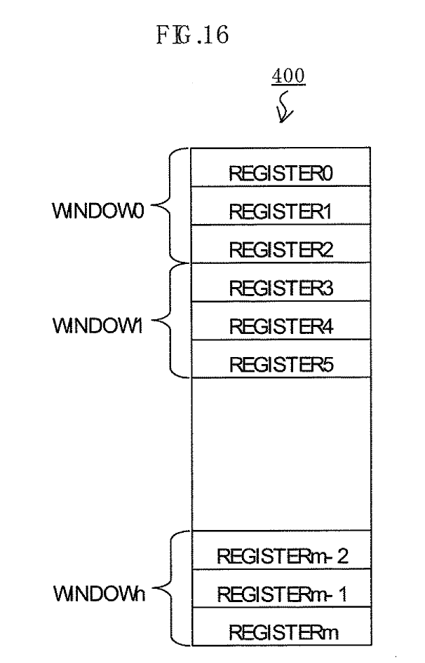

The register file is not limited to the register file of the overlap window scheme as the MRF 10. For example, the register file can also be applied to a huge register file having a flat configuration as shown in FIG. 16.

A register file 400 shown in FIG. 16 has a configuration in which (m+1) windows 0 to m are sequentially arranged. In this case, m is a multiple of 3 which is more than or equal to a predetermined value. The register file 400 is divided into respective areas of three registers, and each divided area is set as a register window. In other words, registers 0 to 2 are set as the window 0 and registers 3 to 5 are set as the window 1. Similarly, the windows 2 to n are set. Here, the window n is configured with registers m-2 to m.

In this way, the register file 400 can be used as alternative of the MRF 10 by dividing the register file 400 having the flat configuration into multiple sequential windows.

As described above, the arithmetic processing unit I of this embodiment can quickly supply the operand data from the register file 100 of the overlap window scheme in the MRF 10 to the arithmetic section 30 without providing the MRF or the CRB and the CWR as in the conventional arithmetic processing unit. Moreover, this embodiment realizes this high-speed reading of the data from the register file 100 by providing the MRF_RA1, the MRF_RA2 and the readout ports io0 to io2, I0 and I1 within the MRF 10, and providing a control circuit for reading the data in the register from the MRF 10, outside the MRF 10.

The register control section 210 is configured with the port assignment control section table 211, the SET register 212, the CWP register 213 and the set, cwp control device 214. However, the CWP register 213 is CWP which has been also included in the conventional arithmetic processing unit, and the MRF_RA1, the MRF_RA2, the port assignment control section table 211 and the SET register 212 can be constructed with smaller circuits in comparison with storage included in the conventional arithmetic processing unit.

Moreover, the set, cwp control device 214 can be realized with the combinational circuit, and its circuit size can be small. Moreover, the execution timing control function 221 for the instruction following the window switching instruction, the rename register release control function 222 and the MRF_RA2 control function 223 included in the instruction control section 220 can also be realized with the small combinational circuit. Moreover, the number of the readout ports provided in the MRF 10 is also a small number, that is, five lines (io0 to io2, I0 and I1). Therefore, in the case of considering the unit as a whole, the arithmetic processing unit 1 of this embodiment can have a smaller circuit size than that of the conventional arithmetic processing unit.

Moreover, the arithmetic processing unit 1 of this embodiment also has lower power consumption since power consumption is not required for transferring the data in the register window between the CRB and the CWR. Moreover, this embodiment has a lower hardware cost than that of the conventional arithmetic processing unit.

It should be noted that the present disclosure is not limited to the above described embodiment, and can be variously transformed and implemented in a range not deviating from the gist of the present disclosure.

Therefore, the register file to which the present disclosure can be applied is not limited to the above described register file. For example, the present disclosure can also be applied to a register file of the overlap window scheme provided with multiple lines of windows for the global register. Moreover, the present disclosure can also be applied to a register file having a configuration in which the address of the current window specified by the current window pointer is randomly updated, instead of being serially updated, each time the window switching instruction is executed.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An arithmetic processing unit comprising:
a register file provided with multiple register windows;
an arithmetic executor which executes an instruction with data retained in said register file as an operand;
a current window pointer which retains address information specifying a register window which becomes a current window, among the multiple register windows included in said register file; and
a controller which controls such that said address information retained by said current window pointer is updated when a window switching instruction for indicating switching of said current window has been decoded;
wherein said arithmetic executor reads data in a first register window specified by the address information before being updated and data in a second register window specified by said updated address information from said register file after the decoding of said window switching instruction has been started until commit of said window switching instruction is started.

2. The arithmetic processing unit according to claim 1, wherein said controller controls such that, when the commit of said window switching instruction has been started, said arithmetic executor reads only the data in said second register window specified by said updated address information from said register file.

3. The arithmetic processing unit according to claim 15 wherein said controller comprises:
a window data readout which reads the data in said first register window and the data in said second register window from said register file, after the start of the decoding of said window switching instruction until the start of the commit of said window switching instruction; and
a register data selective output which selects and outputs data in a register required by said arithmetic among data in multiple registers included in said first register window and said second register window which has been read by said window data readout after the start of the decoding of said window switching instruction until the start of the commit of said window switching instruction.

4. The arithmetic processing unit according to claim 3, wherein said window data readout reads only the data in the registers included in said second register window from said register file when the commit of said window switching instruction is started.

5. The arithmetic processing unit according to claim 3, wherein:
said register file is provided with multiple readout ports which output the data in said first register window and the data in said second register window;
said window data readout outputs the data in said first register window and the data in said second register window from said multiple readout ports after the start of the decoding of said window switching instruction until the start of the commit of said window switching instruction; and
said register data selective output selects and outputs only the data in the register required by said arithmetic executor among the data in said first register window outputted from said multiple readout ports and the data in the multiple registers included in said second register window after the start of the decoding of said window switching instruction until the start of the commit of said window switching instruction.

6. The arithmetic processing unit according to claim 5, wherein each port of said multiple readout ports is used for both outputting the data in said first register window and outputting the data in said second register window.

7. The arithmetic processing unit according to claim 6, wherein each port of said multiple readout ports alternately switches between the data in said first register window and the data in said second register window and outputs the data in said first register window or the data in said second register window each time said window switching instruction is executed.

8. The arithmetic processing unit according to claim 5, wherein:
said register window comprises a first window provided with a register used for passing and receiving an argument between a parent routine and a child routine, a second window provided with a register used individually by an individual routine, and a third window provided with a register shared by all routines; and
said multiple readout ports include multiple first readout ports which output the data in said first window and multiple second readout ports which output the data in said second window.

9. The arithmetic processing unit according to claim 8, wherein said first window is provided with a fourth window which stores the argument passed to the child routine, a fifth window which stores the argument received from the parent routine, and a sixth window used dedicatedly by the routine, and said fourth window and said fifth window are arranged at one end and the other end respectively in said register window.

10. The arithmetic processing unit according to claim 9, wherein the multiple register windows in said register file are logically coupled with one another, and said fourth window in one register window and the fifth window in another register window are shared with respect to the one register window and the other register window which are adjacent to each other.

11. The arithmetic processing unit according to claim 10, wherein the multiple register windows in said register file are logically coupled with one another in a ring shape.

12. The arithmetic processing unit according to claim 11, wherein said multiple first readout ports are divided into a first group which outputs data in said fourth window and data in said fifth window, and a second group which outputs data in said sixth window.

13. The arithmetic processing unit according to claim 12, wherein the number of said first readout ports belonging to said first group is a number larger by one than a total number of said fourth windows and said fifth windows, and the number of said second readout ports belonging to said second group is a number larger by one than the number of said fifth windows.

14. The arithmetic processing unit according to claim 10, wherein said window data readout cyclically switches said first readout ports in which the data in said respective fourth to sixth windows is outputted, each time said window switching instruction is executed.

15. The arithmetic processing unit according to claim 8, wherein after the start of the decoding of the window switching instruction until the commit of the window switching instruction is completed, said window data readout outputs the data in said first windows included in said first register window and said second register window via said multiple first readout ports, and outputs the data in said second windows included in said first register window and said second register window via said multiple second readout ports.

16. The arithmetic processing unit according to claim 15, wherein after the start of the decoding of the window switching instruction until the commit of the window switching instruction is completed, said window data readout performs said data output via all of said first readout ports and all of said second readout ports.

17. The arithmetic processing unit according to claim 15, wherein when the commit of said window switching instruction is started, said window data readout outputs only the data in the first window included in said first register window from some of said multiple first readout ports, and outputs only the data in the second window included in said first register window from some of said multiple second readout ports.

18. The arithmetic processing unit according to claim 8, wherein multiplexers in which the data in said first window and the data in said second window are inputted respectively are provided at said first readout ports and said second readout ports;
said window data readout controls the multiplexers provided at the respective ports of said first readout ports and said second readout ports to selectively output the data in said first windows and the data in said second windows included in said first register window and said second register window from said multiplexers; and
said register data selective output selects and outputs the data in the register required by said arithmetic executor among the data in said first windows and the data in said second windows which are outputted from said multiplexers.

19. The arithmetic processing unit according to claim 3, wherein said controller further comprises:
a current window pointer controller which updates the address information retained by said current window pointer so that said current window is switched in an order of addresses and cyclically used each time the window switching instruction is executed, and storage which stores state information related to all states of said cyclically switched address information; and
a state information output which reads state information corresponding to the updated address information from said storage and outputs the state information to said window data readout, when the address information retained by said current window pointer has been updated.

20. The arithmetic processing unit according to claim 1, further comprising:
a rename register which performs register renaming; and
a rename register controller which controls such that said rename register retains a result of executing a first instruction until said execution result can be read from said register file, when the first instruction and a following instruction executed after said first instruction are in a true data dependency relationship.
